(19) United States
(12) Patent Application Publication
(10) Pub. No.: US 2025/0231300 A1
(43) Pub. Date: Jul. 17, 2025

(54) LIDAR CHIP WITH MULTIPLE DETECTOR ARRAYS

(71) Applicant: Cepton Technologies, Inc., San Jose, CA (US)

(72) Inventors: Chang Seok Shin, Oakland, CA (US); Jun Pei, Saratoga, CA (US); Liqun Han, Pleasanton, CA (US); Dongyi Liao, Mountain View, CA (US); James Haslim, Dublin, CA (US)

(73) Assignee: Cepton Technologies, Inc., San Jose, CA (US)

(21) Appl. No.: 19/027,522

(22) Filed: Jan. 17, 2025

Related U.S. Application Data
(60) Provisional application No. 63/621,922, filed on Jan. 17, 2024.

(51) Int. Cl. G01S 17/894; G01S 7/481; G01S 7/484; G01S 7/4863; G01S 7/4865; G01S 7/489

(52) U.S. Cl. CPC G01S 17/894; G01S 7/4815; G01S 7/4817; G01S 7/484; G01S 7/4863; G01S 7/4865; G01S 7/489

(57) ABSTRACT

A lidar system uses a detector chip have a first column of light sensors and a second column of light sensors, arranged to detect light from pulses of laser light reflected by one or more objects in the environment. The second column of light sensors is arranged to scan a field of view before the first column of light sensor. A processor can adjust power of the emitter, or adjust detector gain of the first column of light sensors, in response to data from the second column of light sensors scanning the field of view, so that light in a dynamic range of the first column of sensors can be used to generate data for a three-dimensional point cloud.

### CROSS-REFERENCES TO RELATED APPLICATIONS

This application claims the benefit of U.S. Provisional Patent Application No. 63/621,922, filed on Jan. 17, 2024, which is incorporated by reference in its entirety for all purposes.

### BACKGROUND

Three-dimensional sensors can be applied in autonomous vehicles, drones, robotics, security applications, and the like. For example, lidar projects an optical beam and detects light of the optical beam reflected by one or more objects in an environment. Lidar can be used to create a three-dimensional map of the environment, or portion thereof, based on detecting reflected light of the optical beam. Scanning lidar sensors may achieve high angular resolutions appropriate for such applications at an affordable cost. An example of a scanning lidar system is provided in U.S. Pat. No. 10,690,754, granted on Jun. 23, 2020, which is incorporated by reference for all purposes. However, improved scanning systems, apparatuses, and/or methods are desired.

### SUMMARY

This disclosure relates, without limitation, to lidar and overcoming saturation of lidar photodetectors.

In certain configurations, a system for lidar comprises an emitter arranged to emit pulses of light; a mirror arranged to reflect the pulses of light into an environment; a detector arranged to detect light from the pulses of light reflected by one or more objects in the environment, wherein: the detector comprises a first column of light sensors and a second column of light sensors, and the second column of light sensors is arranged to scan a field of view before the first column of light sensor; and/or a memory device comprising instructions that, when executed by one or more processors, causes the one or more processors to: adjust power of the emitter, or adjust detector gain of the first column of light sensors, in response to data from the second column of light sensors scanning the field of view, and/or generate data for a three-dimensional point cloud, the point cloud including at least one data point of the one or more objects in the environment based on light detected by one or more light sensors in the first column of light sensors.

In certain configurations, a system for lidar comprises an emitter arranged to emit pulses of light; a mirror arranged to reflect the pulses of light into an environment; a detector arranged to detect light from the pulses of light reflected by one or more objects in the environment, wherein: the detector comprises a first column of light sensors and a second column of light sensors, and the first column of light sensors is arranged to detect light at a different intensity than the second column of light sensors; and a memory device comprising instructions that, when executed by one or more processors, causes the one or more processors to generate data for a three-dimensional point cloud, the point cloud including at least one data point of the one or more objects in the environment based on light detected by the detector.

In some configurations, the different intensity is caused by the emitter reducing power of light pulses after the second column of light sensors detects light above a threshold; the different intensity is caused by the emitter increasing power of light pulses after the second column of light sensors detects light below a threshold; the different intensity is caused by one or more filters in front of the first column of light sensors and/or in front of the second column of light sensors; the different intensity is caused by light sensors in the first column being less sensitive to light or changing gain to amplifiers receiving signals from light sensors in the first column; the detector comprises a third column of light sensors; the first column of light sensors is between the second column of light sensors and the third column of light sensors; the first column of light sensors is arranged to detect light at a different intensity than the third column of light sensors; the mirror is arranged to spin or oscillate; the instructions cause the one or more processors to use pixel data from one or more columns of light sensors that has a desired data range; the different intensity is caused by a gain of the first column of light sensors being reduced or increased compared to a gain of the second column of light sensors; the emitter comprises a first column of lasers and a second column of lasers; the different intensity is caused by the first column of lasers emitting light at a different power than the second column of lasers; the detector further comprises four or more columns of light sensors, wherein each column of light sensors detects light at different intensities; the detector further comprises an image sensor that is arranged to create a two-dimensional color image; the image sensor is on a same chip as the first and second columns of light sensors; the image sensor, the first column of light sensors, and the second column of light sensors share a common lens; the image sensor comprises three columns of light sensors with three different colored filters; the system comprises an image sensor on a separate chip than the detector; the system comprises a beam splitter sending a first portion of light to the image sensor and a second portion of light to the detector; the mirror is arranged for scanning the pulses of light in a direction orthogonal to a direction of the first column of light sensors; the mirror is a first mirror; the system comprises a second mirror; the second mirror is arranged to scan the pulses of light in a direction parallel to the direction of the first column of light sensors; generating the data for the three-dimensional point cloud includes adding data from a light sensor in the first column to data from a light sensor in the second column; the second column of light sensors is arranged to detect stray light emitted toward and received by the first column of light sensors; and/or the detector comprises a third column of light sensors for detecting thermal light from the environment.

In certain configurations, a method for lidar comprises emitting, using one or more lasers, pulses of light; reflecting, using a mirror, the pulses of light into an environment; detecting, using a detector, light from the pulses of light reflected by one or more objects in the environment, wherein the detector comprises a first column of light sensors and a second column of light sensors and the first column of light sensors detect light at a different intensity than the second column of light sensors; and generating data for a three-dimensional point cloud based on light detected by the detector, wherein the three-dimensional point cloud includes at least one data point of the one or more objects in the environment.

In certain embodiments, a detector chip comprises a single column of photodetectors for detecting reflected laser light for lidar (e.g., with an IR filter) and one, two, or three columns of photodetectors for imaging ambient light (e.g., with red, green, and blue filters) on the same chip.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 illustrates an embodiment of a lidar sensor for three-dimensional imaging.

FIG. 2 illustrates an embodiment of a lidar sensor with a rotating mirror and a routing mirror.

FIG. 3 depicts an embodiment of a chip for lidar sensing.

FIG. 4 depicts an embodiment of a lidar system having an emitter and a detector that use arrays.

FIG. 5 depicts an embodiment of a chip comprising multiple columns of photodetectors.

FIG. 6 depicts the chip of FIG. 5 incorporated into an embodiment of a lidar system.

FIG. 7 depicts an embodiment of a chip comprising a lidar array and an image sensor array.

FIG. 8 depicts an embodiment of a system having a lidar chip separate from camera chip.

FIG. 9 illustrates a flowchart of an embodiment of a process for lidar.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Lidar sensors are used to create a three-dimensional image of an object space within a field of view (FOV) of the sensor. One common difficulty with accurate imaging generation is that some common objects found in driving scenes, particularly retro-reflective objects such as street signs and license plates, can easily be 1000 times brighter than normal objects when actively illuminated by the sensor. This can cause saturation of the photodetector and associated electronics. It can also result in “blooming” where small amounts of stray light from imperfections (e.g., imperfect lenses, dust on the windshield, and reflections off interior components such as the lens barrel) can cause false detections around a retroreflector, making it appear much bigger than it really is. Such blooming can be particularly troublesome when, for example, the image of a speed limit sign blooms into the driving lane, causing the car to brake for a perceived obstruction in the road when there is none.

A possible architecture for an imaging lidar system comprises a 1D array of sensors integrated onto a silicon integrated circuit (“IC” or “chip”). Illumination may be a vertical line of laser light (e.g., a 1D array of lasers). Both the laser line and the return photons are scanned synchronously (e.g., by separate scanning optics or together by the same scanning optic(s)) so that the laser photons reflected from one or more objects in a field of view of the lidar system are returned and focused onto a corresponding detector. Multiple columns of photodetectors may be used to increase a dynamic range of detection to allow imaging of bright as well as dim objects. Multiple columns may also be used to provide additional imaging modes such as color camera images or thermal infrared images.

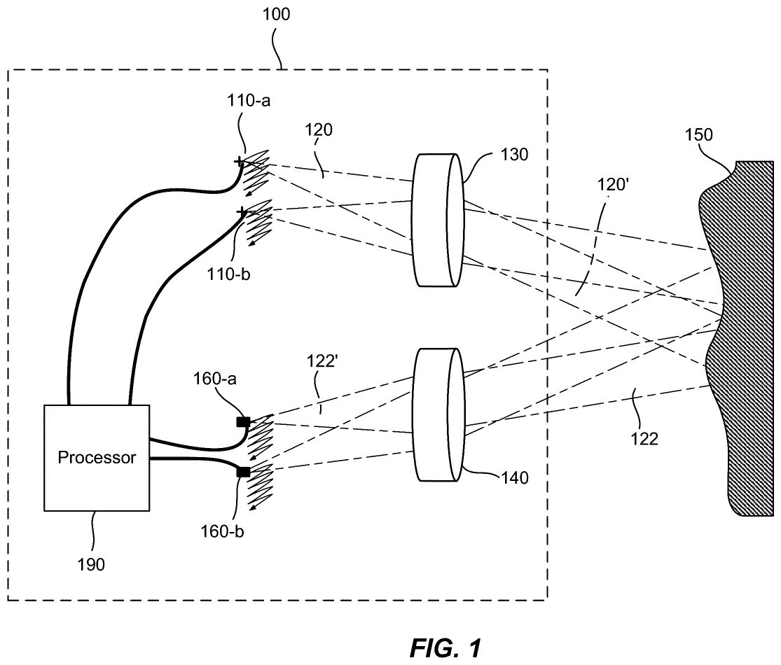

FIG. 1 illustrates an embodiment of a LiDAR sensor 100 for three-dimensional imaging. The LiDAR sensor 100 includes an emission lens 130 and a receiving lens 140. The LiDAR sensor 100 includes a light source 110-a disposed substantially in a back focal plane of the emission lens 130. The light source 110-a is operative to emit a light pulse 120 from a respective emission location in the back focal plane of the emission lens 130. The emission lens 130 is configured to collimate and direct the light pulse 120 toward an object 150 located in front of the LiDAR sensor 100. For a given emission location of the light source 110-a, the collimated light pulse 120′ is directed at a corresponding angle toward the object 150.

A portion 122 of the collimated light pulse 120′ is reflected off of the object 150 toward the receiving lens 140. The receiving lens 140 is configured to focus the portion 122′ of the light pulse reflected off of the object 150 onto a corresponding detection location in the focal plane of the receiving lens 140. The LiDAR sensor 100 further includes a detector 160-a disposed substantially at the focal plane of the receiving lens 140. The detector 160-a is configured to receive and detect the portion 122′ of the light pulse 120 reflected off of the object at the corresponding detection location. The corresponding detection location of the detector 160-a is optically conjugate with the respective emission location of the light source 110-a.

The light pulse 120 may be of a short duration, for example, 10 ns pulse width. The LiDAR sensor 100 further includes a processor 190 coupled to the light source 110-a and the detector 160-a. The processor 190 is configured to determine a time of flight (TOF) of the light pulse 120 from emission to detection. Since the light pulse 120 travels at the speed of light, a distance between the LiDAR sensor 100 and the object 150 may be determined based on the determined time of flight.

One way of scanning a laser beam (e.g., light pulse 120′) across a FOV is to move the light source 110-a laterally relative to the emission lens 130 in the back focal plane of the emission lens 130. For example, the light source 110-a may be raster scanned to a plurality of emission locations in the back focal plane of the emission lens 130 as illustrated in FIG. 1. The light source 110-a may emit a plurality of light pulses at the plurality of emission locations. Each light pulse emitted at a respective emission location is collimated by the emission lens 130 and directed at a respective angle toward the object 150, and impinges at a corresponding point on the surface of the object 150. Thus, as the light source 110-a is raster scanned within a certain area in the back focal plane of the emission lens 130, a corresponding object area on the object 150 is scanned. The detector 160-a may be raster scanned to be positioned at a plurality of corresponding detection locations in the focal plane of the receiving lens 140, as illustrated in FIG. 1. The scanning of the detector 160-a is typically performed synchronously with the scanning of the light source 110-a, so that the detector 160-a and the light source 110-a are always optically conjugate with each other at any given time.

By determining the time of flight for each light pulse emitted at a respective emission location, the distance from the LiDAR sensor 100 to each corresponding point on the surface of the object 150 may be determined. In some embodiments, the processor 190 is coupled with a position encoder that detects the position of the light source 110-a at each emission location. Based on the emission location, the angle of the collimated light pulse 120′ may be determined. The X-Y coordinate of the corresponding point on the surface of the object 150 may be determined based on the angle and the distance to the LiDAR sensor 100. Thus, a three-dimensional image of the object 150 may be constructed based on the measured distances from the LiDAR sensor 100 to various points on the surface of the object 150. In some embodiments, the three-dimensional image may be represented as a point cloud, i.e., a set of X, Y, and Z coordinates of the points on the surface of the object 150.

In some embodiments, the intensity of the return light pulse 122′ is measured and used to adjust the power of subsequent light pulses from the same emission point, in order to prevent saturation of the detector, improve eye-safety, or reduce overall power consumption. The power of the light pulse may be varied by varying the duration of the light pulse, the voltage or current applied to the laser, or the charge stored in a capacitor used to power the laser. In the latter case, the charge stored in the capacitor may be varied by varying the charging time, charging voltage, or charging current to the capacitor. In some embodiments, the reflectivity, as determined by the intensity of the detected pulse, may also be used to add another dimension to the image. For example, the image may contain X, Y, and Z coordinates, as well as reflectivity (or brightness).

The angular field of view (AFOV) of the LiDAR sensor 100 may be estimated based on the scanning range of the light source 110-a and the focal length of the emission lens 130 as,

$$AFOV = 2 {tan}^{- 1} ( \frac{h}{2 f} ) ,$$

where h is scan range of the light source 110-a along certain direction, and f is the focal length of the emission lens 130. For a given scan range h, shorter focal lengths would produce wider AFOVs. For a given focal length f, larger scan ranges would produce wider AFOVs. In some embodiments, the LiDAR sensor 100 may include multiple light sources disposed as an array at the back focal plane of the emission lens 130, so that a larger total AFOV may be achieved while keeping the scan range of each individual light source relatively small. Accordingly, the LiDAR sensor 100 may include multiple detectors disposed as an array at the focal plane of the receiving lens 140, each detector being conjugate with a respective light source. For example, the LiDAR sensor 100 may include a second light source 110-b and a second detector 160-b, as illustrated in FIG. 1. In other embodiments, the LiDAR sensor 100 may include four light sources and four detectors, or eight light sources and eight detectors. In one embodiment, the LiDAR sensor 100 may include eight light sources arranged as a 4×2 array and eight detectors arranged as a 4×2 array, so that the LiDAR sensor 100 may have a wider AFOV in the horizontal direction than its AFOV in the vertical direction. According to various embodiments, the total AFOV of the LiDAR sensor 100 may range from about 5 degrees to about 15 degrees, or from about 15 degrees to about 45 degrees, or from about 45 degrees to about 120 degrees, depending on the focal length of the emission lens, the scan range of each light source, and the number of light sources.

The light source 110-a may be configured to emit light pulses in the near infrared wavelength ranges. The energy of each light pulse may be in the order of microjoules, which is normally considered to be eye-safe for repetition rates in the KHz range. For light sources operating in wavelengths greater than about 1500 nm (in the near infrared wavelength range), the energy levels could be higher as the eye does not focus at those wavelengths. The detector 160-a may comprise a silicon avalanche photodiode, a photomultiplier, a PIN diode, or other semiconductor sensors.

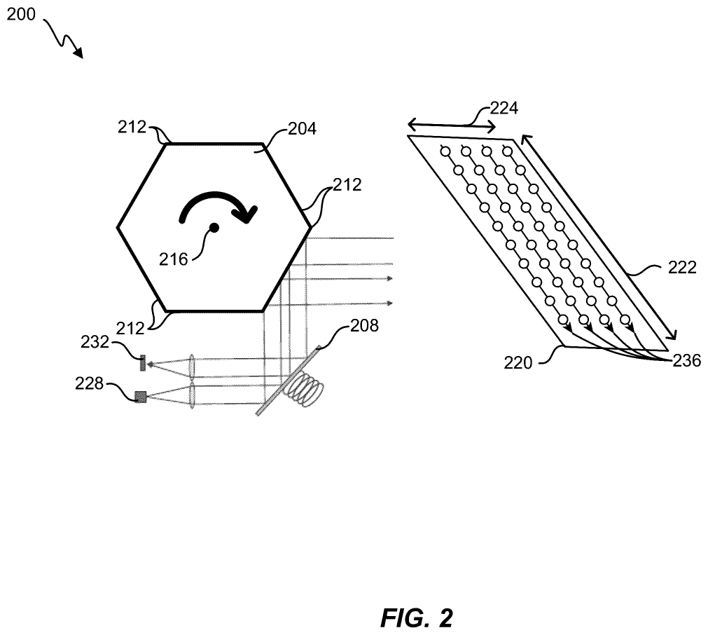

FIG. 2 illustrates an embodiment of a lidar system 200 having a rotating mirror 204 and a routing mirror 208. The rotating mirror 204 can be a polygonal mirror with reflective facets 212. The rotating mirror 204 rotates (e.g., spins in a complete circle) about a vertical axis 216. Light is reflected by the rotating mirror 204 into a field of view (FOV) 220. The FOV 220 has a horizontal 222 component and a vertical 224 component. For example, a lidar system can be positioned on a car so that the vertical 224 component of the FOV 220 is in the direction of gravity, and the horizontal 222 component of the FOV 220 is orthogonal to the direction of gravity. Though the rotating mirror 204 is shown as a spinning mirror, in some embodiments, the rotating mirror rotates back and forth about an axis in an oscillating motion.

The rotating mirror 204 is used for scanning, horizontally, one or more laser beams (e.g., a pulsed laser beam) into the FOV 220 of the lidar system 200. The rotating mirror 204 has a number of planar, equal sized mirror facets fabricated on a spinning rotor. Though the number of facets 212 shown in FIG. 2 is six, the number of facets 212 could be equal to or greater than 2, 3, or 4 and/or equal to or less than 4, 5, 6, 7, 8, 10, or 12. A spinning mirror, such as the rotating mirror 204 shown in FIG. 2, has low vibration, low power requirement, and a linear scan characteristic. In an imaging lidar application, the rotating mirror 204 scans in the horizontal direction. To achieve high resolution in the other (e.g., vertical) direction, a vertical array of lasers (e.g., a large vertical array) and/or a galvo mirror may be used. The lidar system 200 depicted in FIG. 2 includes a laser 228 and a detector 232. Though only one laser 228 and one detector 232 are shown in FIG. 2, it is to be understood that more than one laser 228 and/or detector 232 can be used (e.g., a laser array and/or a detector array are used).

In some embodiments, a rotating polygon mirror is used to scan one or more lasers 228 in the horizontal direction, and the routing mirror 208 is used to fold a beam path to make a more compact layout. The routing mirror 208 in FIG. 2 is also used to position light pulses from the laser 228 in a vertical direction by dynamically tilting back and forth in the vertical direction (e.g., about a horizontal axis). This arrangement can achieve high resolution in the vertical direction while reducing and/or minimizing a number of lasers and/or can also make the lidar system 200 more compact. As shown in FIG. 2, the routing mirror 208 can effectively increase a number of scanlines 236 in the vertical 224 component of the FOV 220. This can be done with a single laser and/or with a vertical array of lasers. Each dot on the scanline 236 represents a laser pulse.

In some embodiments, the scanlines 236 are in discrete vertical steps. For example, the routing mirror 208 rotates to discrete positions for each scanline 236 (e.g., instead of the routing mirror 208 continuously rotating). If the routing mirror 208 continuously rotates, the scanline bends, and laser pulses are not emitted in a straight horizontal line. Having a scanline of laser pulses be in a curved line might not pose much of a problem if only one laser 228 is used. However, if multiple lasers are used, having straight scanlines can be helpful for creating a scan pattern in the FOV 220 with a desired density of data points (e.g., having light pulses from lasers spaced apart in a desired density pattern).

In some embodiments, a system for lidar (e.g., lidar system 200) comprises an illumination source comprising a plurality of lasers (e.g., an array of lasers comprising laser 228) and a mirror system (e.g., comprising the rotating mirror 204 and the routing mirror 208). The mirror system is arranged to reflect light from the illumination source into an environment within a field of view (e.g., FOV 220). The mirror system comprises a mirror (e.g., rotating mirror 204) arranged to rotate to reflect light from the illumination source to scan light from the plurality of lasers horizontally within the field of view of the system. The mirror system is arranged to reflect light from the illumination source (e.g., using routing mirror 208) to position light from the plurality of lasers vertically within the field of view with discrete vertical steps (e.g., scanlines 236 are separated by discrete vertical steps). The scanlines 236 are in straight (e.g., horizontal) lines.

Additional lidar sensors are described in commonly owned U.S. patent application Ser. No. 15/267,558 filed Sep. 15, 2016, Ser. No. 15/971,548 filed on May 4, 2018, Ser. No. 16/504,989 filed on Jul. 8, 2019, Ser. No. 16/775,166 filed on Jan. 28, 2020, Ser. No. 17/032,526 filed on Sep. 25, 2020, Ser. No. 17/133,355 filed on Dec. 23, 2020, Ser. No. 17/205,792 filed on Mar. 18, 2021, Ser. No. 17/380,872 filed on Jul. 20, 2021, and Ser. No. 18/531,507 filed on Dec. 6, 2023, the disclosures of which are incorporated by reference for all purposes.

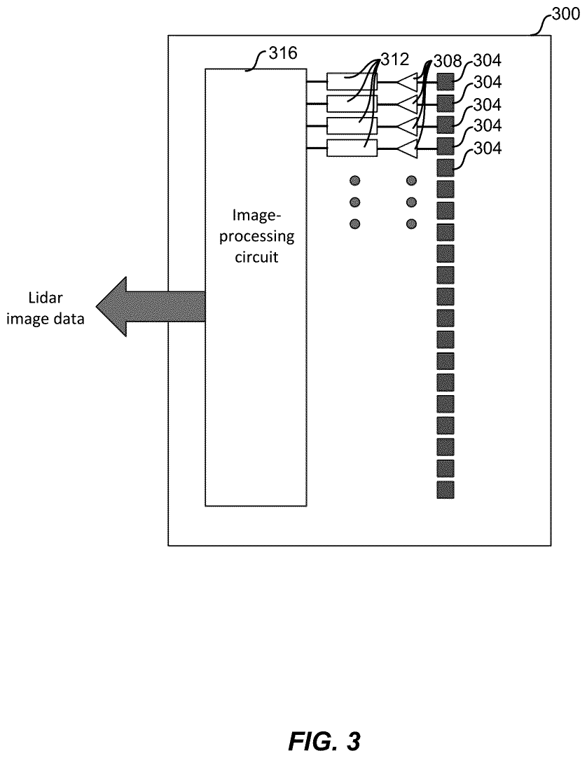

FIG. 3 depicts a simplified embodiment of chip 300 for lidar sensing. The chip 300 comprises a column of photodetectors 304. The column of photodetectors 304 can be referred to an as array; in this case a one-dimensional array. The photodetectors 304 are optical sensors. A two-dimensional scan of a field of view can be built up by scanning the view of the photodetectors 104 across the field of view (FOV) horizontally (and/or vertically), for example by using a scanning mirror such as a galvanometer mirror (“galvo”) and/or a rotating polygonal mirror (e.g., as shown in FIG. 2). A laser, or lasers, is arranged to provide pulses of light that is scanned across the FOV (e.g., by the same scanning mirror), thus illuminating object(s) in an environment (e.g., object(s) within the FOV of the lidar system) being imaged by the lidar detector.

Photodetectors 304 for lidar are typically infrared detectors, although other wavelengths may be used. The photodetectors 304 can be simple photodiodes, avalanche photodiodes (APDs), single photon detectors (SPADs), or arrays of SPADs, often called silicon photomultipliers (SiPMs). Each photodetector 304 is coupled to a time of flight (ToF) detector through an optional amplifier, typically a transimpedance amplifier. The ToF detector determines the time between the laser pulse and the detection event, in order to calculate the distance from the lidar sensor to the detected object. The lidar system uses an active laser illumination system that sends out short (e.g., nanosecond duration) pulses of laser light. Each photodetector may be illuminated by its own laser, or a group of lasers, or the entire column of detectors may share a single laser. Examples of a laser include a fiber coupled laser, an edge emitting diode laser (EEL), and a vertical cavity surface emitting laser (VCSEL).

The transimpedance amplifier (TIA) 308 can amplify a signal from the photodetector 304. The amplified signal is then be sent to the time-of-flight (ToF) detector 312 to calculate a distance to a reflection. An image processing circuit 316 is used to calculate data for a three-dimensional point cloud of the environment within the FOV of the lidar sensor, which can be used to generate lidar image data. In some embodiments, a memory device comprises instructions that, when executed by one or more processors (e.g., image-processing circuit 316 and/or ToF detector 312), causes the one or more processors to generate data for a three-dimensional point cloud, which includes at least one data point for one or more objects in the environment, based on light detected by the detector. The chip 100 can be used as a detector in a lidar system (e.g., detector 232 in FIG. 2).

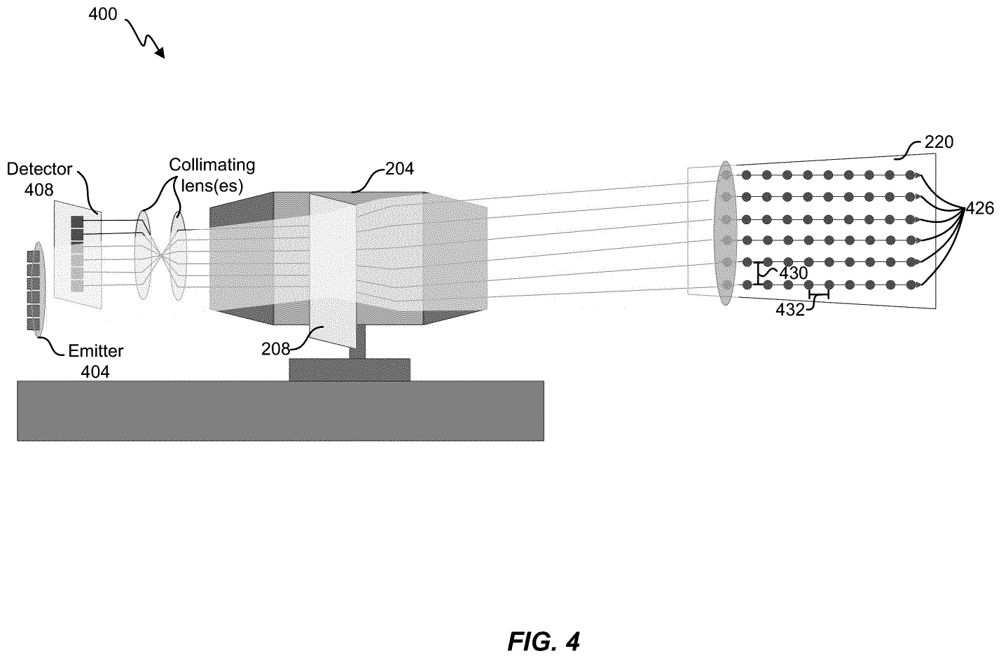

FIG. 4 depicts and embodiment of a lidar system 400 having an emitter 404 and a detector 408 that use arrays. The lidar system 400 comprises a rotating mirror 204 and a routing mirror 208. The emitter 404 comprises a one-dimensional laser array arranged to emit pulses of light. The routing mirror 208 and the rotating mirror 204 are arranged to reflect the pulses of light into an environment within a FOV 220 of the lidar system 400. The detector 408 (e.g., comprising chip 300) is arranged to detect light from the pulses of light reflected by one or more objects in the environment.

The rotating mirror 204 (e.g., a first mirror), is arranged for scanning pulses of light in a horizontal direction, or a direction orthogonal to a direction of a column of sensors. For example, the column of photodetectors 304 of chip 300 in FIG. 3 are arranged vertically in detector 408 in FIG. 4, and the rotating mirror 204 scans pulses of light form photodetectors in a horizontal direction along scanlines 426. Vertical resolution 430 can be determined by the vertical array size and/or pitch of the photodetectors 304 on chip 300. Horizontal resolution 432 can be determined by scan speed of the rotating mirror 204 and/or firing rate of the emitter 404.

In some embodiments, the routing mirror 208 (e.g., a second mirror) is arranged to scan pulses of light vertically (e.g., in a direction parallel to the direction of the first column of sensors). For example, pulses of light are scanned vertically above, below, and/or interspersed with scanlines 426 shown in FIG. 4. Though FIG. 4 shows and array of lasers and an array of photodetectors equal to six each, other numbers of lasers and photodetectors could be used in one column of each array. For example, there could be equal to or greater than 2, 5, 10, 20, 30, 40, or fifty components in one column and/or equal to or less than 40, 70, 100, 256, or 512 components in one column. A size of chip, a size of component, and/or electronics on the chip can limit the number of components in one column or array.

Some lidars have the capability to reduce the intensity of the laser pulses when a bright object, such as a retroreflector, comes into the field of view, so that the detectors are not saturated or blinded. However, in a system, such as shown in FIGS. 3 and 4, the reduction of laser intensity is a reactive action, not proactive action, as there is no advance knowledge (e.g., in one scanline 426) of the introduction of a retroreflective object in the FOV. By the time a bright object is detected, and the laser power reduced, one or more frames of the image may already have compromised data.

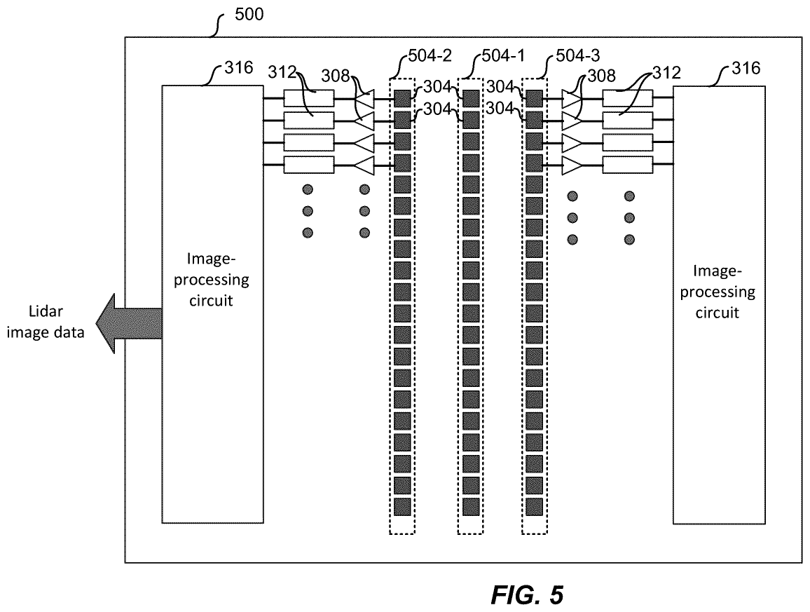

FIG. 5 depicts an embodiment of a chip 500 comprising multiple columns 504 of photodetectors 304. The chip 500 is shown comprising a first column 504-1 of photodetectors 304, a second column 504-2 of photodetectors 304, and a third column 504-3 of photodetectors 304. Though three columns 504 are shown in FIG. 5, there could be fewer (e.g., two) or greater (e.g., four, five, six, or more). The chip 500 comprises TIAs 308, ToF detectors 312, and image processing circuits 316.

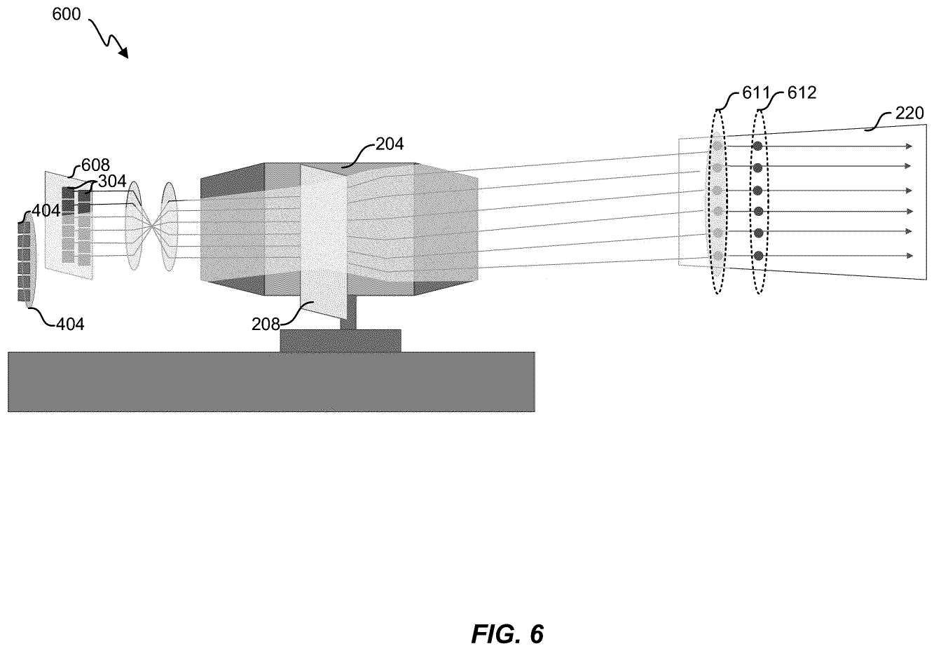

FIG. 6 depicts an embodiment of the chip 500 incorporated into an embodiment of a lidar system 600. The lidar system 600 comprises an emitter 404, a detector 608, rotating mirror 204, and routing mirror 208. The detector 608 comprises chip 500. The chip 500 comprises the first column 504-1 of photodetectors 304 and the second column 504-2 of photodetectors 304.

The second column 504-2 of photodetectors 304 scans the FOV 220 ahead of and prior to the first column 504-1 of photodetectors 304. The first column 504-1 and second column 504-2 of photodetectors are scanned across the same, or approximately the same, FOV 220. For example, the FOV that the first column 504-1 is scanned across overlaps the FOV that the second column is scanned across by an amount equal to or greater than 90%, 95%, 97%, 98%, 99%, or 100%; in some embodiments, the difference is equal to or less than five, three, two, or one pixel width.

FIG. 6 shows pixels in a first region 611 in the FOV 220 imaged by the first column 504-1 of sensors and pixels imaged in a second region 612 of the FOV 220 by the second column 504-2 of sensors at the same time as the pixels in the first region 611 are imaged by the first column 504-1 of sensors. The first column 504-1 of photodetectors 304 can detect light at a different intensity than the second column 504-2 of photodetectors 304. For example, scanning first with the second column 504-2 of photodetectors 304 (e.g., at region 612) gives the processor time to adjust the laser illumination pulse power to prevent saturation of the first column 504-1 of photodetectors 304, if the lidar system 600 detects an overly bright object by the second column 504-2 of photodetectors 304. In some situations, the second column of photodetectors 304 may detect light below a threshold power and the system increases the laser power so the more intense light is detected by the first column 504-1 of photodetectors 304. Accordingly, the second column 504-2 is used to scan objects in a scene first followed by the first column 504-1, and a processor is able to use information from one or more photodetectors 504 in the second column 504-2 to adjust (e.g., increase or decrease) laser power and/or detector gain for the first column 504-1. In some configurations, different columns 504 of detectors have different filters (e.g., different transmittance values of neutral density filters) and/or different sensitivity values of photodetectors 304.

In some systems using an oscillating mirror rather than a spinning rotating mirror, a direction of scanning can periodically reverse. In this case, the processor can base the laser power on whichever column scans the FOV 220 first, such that the later column to scan an object uses an optimized laser power for illumination. A third column of detectors (e.g., 504-3 in FIG. 5) may be added on an opposite side from the second column 504-2 of detectors, so that depending on the scan direction, either the second column 504-2 or the third column 504-3 may be used to detect an overly bright object.

Is some configurations, the second column 504-2 of detectors may use less sensitive detectors or lower gain amplifiers. This will allow for non-saturated image data even if the laser power remains high. The processor can pick pixel data from light sensors in one or more columns 504 that have a desired data range (e.g., below a high threshold value and/or above a low threshold value). The third column 504-3 may have even less sensitive detectors, lower gain amplifiers, and/or be arranged so that the second column 504-3 is between the first column 504-1 and the third column 504-3. Additionally, rather than reduce the laser power (or in addition to reducing the laser power), the processor may reduce the gain of a front-end detection system electronically by techniques such as variable gain amplifiers or reduced bias of the photodetector(s). In some configurations, laser intensity is cycled so that different laser powers are emitted to be detected by different columns of detectors, and the system selects data from one or more columns 504 (e.g., from columns that are not saturated).

In some configurations, laser illumination may be arranged such that it primarily illuminates the first column 504-1 and illuminates the second column 504-2 with much reduced intensity. Thus, bright objects will be less likely to saturate the light sensor in the second column 504-2. In some configurations, a second set of laser(s) may be used to separately illuminate the second column 504-2, with a laser power that is higher, or lower, than the laser power used to illuminate the first column 504-1.

In some implementations, an array of detectors may be a 2-dimensional array. One or more columns 504 may be chosen to provide advance data for setting the laser power. The column chosen may be configurable depending on the brightness of the object(s) being imaged. In some configurations, the laser intensity may be arranged to diminish (e.g., gradually or in steps) across several columns of photodetectors. The processor can choose which column, or columns, has the correct level of illumination for an object in the FOV 220. Also note that “rows” may be substituted for “columns” and “horizontal” for “vertical” without changing the nature of the invention. For example, the scanning can be in the vertical direction rather than the horizontal direction, and the photodetectors arranged in rows rather than columns.

In some configurations, different intensity at light sensors is caused by the emitter reducing power of light pulses after the second column of light sensors detect light above a threshold; the different intensity can be caused by one or more filters in front of the first column of light sensors or the second column of light sensors; the different intensity is caused by light sensors in the second column being less sensitive or having lower gain amplifiers than light sensors in the first column; the detector comprises a third column of light sensors; the first column of light sensors is between the second column of light sensors and the third column of light sensors; and the first column of light sensors detect light at a different intensity than the third column of light sensors; the mirror is arranged to oscillate or rotate (e.g., spin in 360 degrees); the instructions cause the one or more processors to use pixel data from one or more columns of light sensors that has a desired data range (e.g., not saturated); the different intensity is caused by the gain of the first column of light sensors being reduced compared to the gain of the second column of light sensors; the emitter comprises a first column of lasers and a second column of lasers; and the different intensity is caused by the first column of lasers emitting light at a different power than the second column of lasers; the detector comprises four or more columns of light sensors, wherein each column of light sensors detect light at a different intensity than the other columns of light sensors; the detector comprises three, four, or more columns of light sensors, wherein each column of light sensors detect light at a different wavelength than the other columns of light sensors (e.g., a light sensor with four columns: R, G, B, and IR for detecting ambient light on the same chip as one, two, three, or more columns used to detect reflected laser light; with an IR filter for the IR ambient light not overlapping with a bandwidth of light used by the emitter); generating the data for the three-dimensional point cloud includes adding data from light sensors in adjacent columns; and/or the second column of light sensors is arranged to detect stray light emitted toward and received by the first column of light sensors.

Lidar sensor data can be combined with data from other sensors, such as cameras, to improve object detection and/or provide redundancy. Color data can also be important for traffic light and brake light detection. One problem with such sensor fusion is that it can be difficult to perfectly overlay the lidar image with the camera image due to different distortion characteristics in lenses. Further compounding the problem is that a protective cover (in some cases the windshield of the car) can introduce further image distortion that is different between the Lidar sensor and the camera, and this distortion can change if the cover (or windshield) is replaced during a service event.

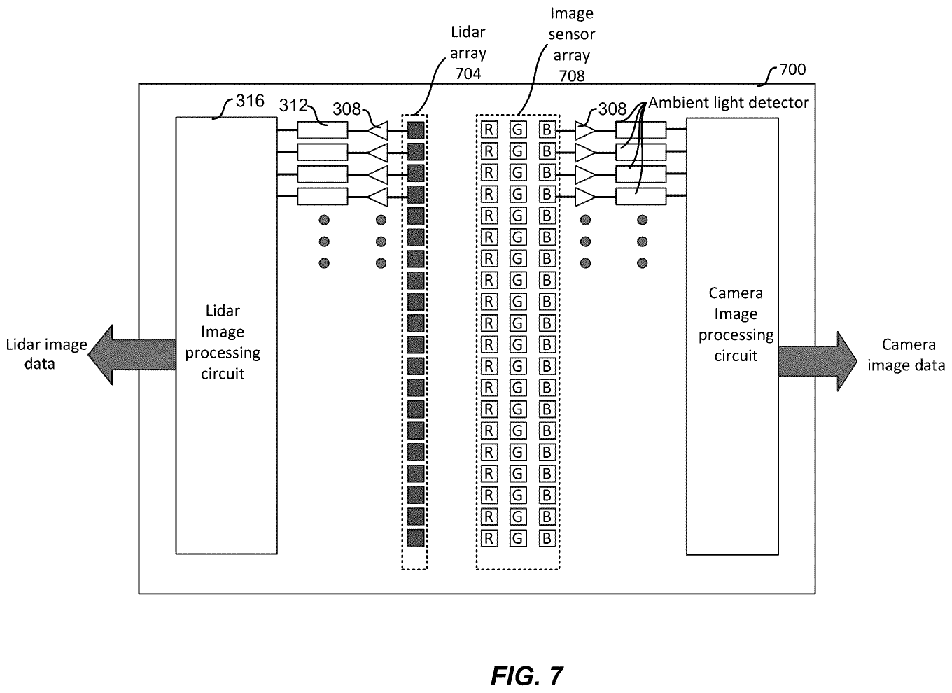

FIG. 7 depicts an embodiment of a chip 700 comprising a lidar array 704 and an image sensor array 708. By integrating a camera sensor and a lidar sensor onto a single sensing device (e.g., on a silicon integrated circuit), and using a common lens for imaging, difficulties in overlaying the lidar and camera images can be reduced or completely avoided. In FIG. 7, an example of a silicon sensor that incorporates a 1D array of photodetectors for lidar and a second array of photodetectors for camera imaging is shown. The image sensor array 708 could be a single column of detectors for a black and white image, a set of three or more columns of detectors for color imaging, or a combination of color sensors on a single column. The lidar sensor array 704 could be one column (e.g., as discussed in conjunction with FIG. 3) or multiple columns (e.g., as discussed in conjunction with FIG. 5). In FIG. 7, the image sensor array 708 is used to image light from the FOV using red (R), green (G), and blue (B) sensitive photodetectors, but other schemes could be used.

In FIG. 7, the lidar sensor array 704 and the image sensor array 708 are physically close enough to share a common lens and scanning mechanism, with only a minimally-significant offset between the images that can be removed by calibrations and/or image processing. In some configurations, multiple lidar photodetector arrays are used in combination with one or more camera photodetector arrays.

In some configurations, a detector further comprises an image sensor (e.g., image sensor array 708) that is arranged to create a two-dimensional color image, wherein the image sensor is on a same chip as the first and second columns of light sensors. For example, the chip 700 could be used as part of the detector 608 in FIG. 6. The image sensor, the first column of light sensors, and the second column of light sensors can share a common lens (e.g., a receive lens). The image sensor can comprise three columns of light sensors with three different colored filters (e.g., shown as “R,” “G,” and “B” in FIG. 7).

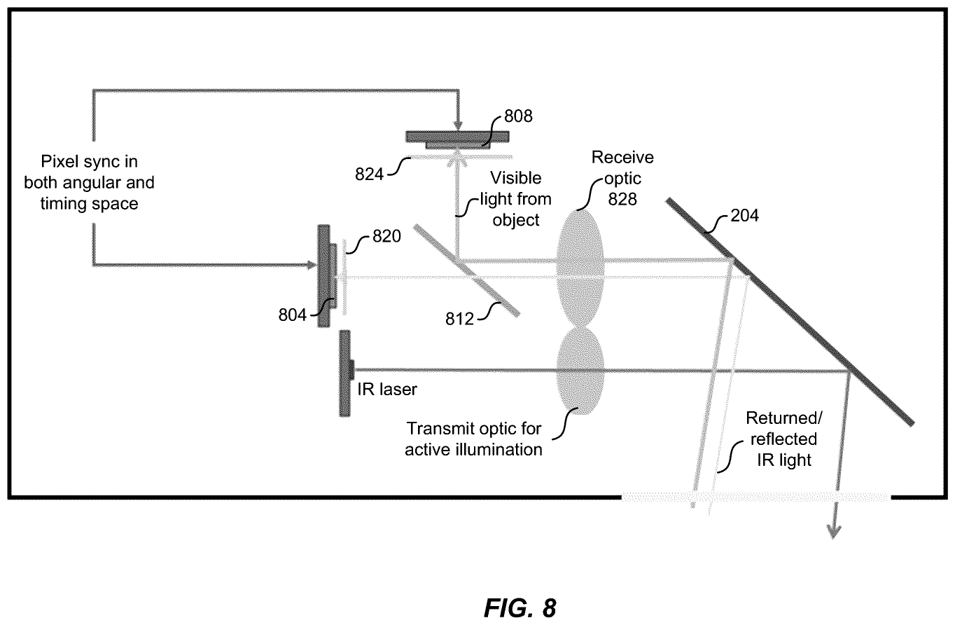

FIG. 8 depicts an embodiment of lidar system having a lidar chip 804 and a camera chip 808 on two separate chips. A beam splitter 812 (e.g., high pass IR, high reflection for visible) is used to direct infrared light to the lidar chip 804 and visible light to the camera chip 808. For example, the lidar chip 804 could be

The camera chip 808 has a matching array of “ambient” or visible light detectors. Ambient light detectors are not arranged to image light from laser reflections off objects but are used to image objects in a scene using light naturally occurring (e.g., from the sun), or already occurring (e.g., from headlights of a car and/or street lights) in the scene. While an array of sensors (e.g., a number of sensors in a column) on the camera chip 808 may usually match 1:1 with an array of sensors on the lidar chip 804, it is possible that there may be more or fewer sensors on the camera chip 808, resulting in higher or lower resolution of the camera image relative to the lidar image. For a full-color image, there may be 3 or more columns of sensors, each with a color filter over it. FIG. 7 shows three columns of sensors, one column for red, one column for green, and one column for blue. The sensors can be simple photodiodes, avalanche photodiodes (APDs), single photon detectors (SPADs), and/or arrays of SPADs, often called silicon photomultipliers (SiPMs). The output of the photodetectors is then amplified, digitized, and/or processed to form a camera image. In some configurations, a system comprises an image sensor (e.g., 808 in FIG. 8) on a separate chip than the lidar detector (e.g., lidar chip 804 in FIG. 8) and/or a beam splitter (e.g., beam splitter 812) arranged for sending a first portion of light to the image sensor (e.g., to the camera chip 808) and a second portion of light to the detector (e.g., lidar chip 804). The lidar chip 804 and the camera chip 808 pixels can be synced in both angular and timing space.

In FIG. 8, a narrow-band IR filter 820 is arranged between the beam splitter 812 and the lidar chip 804, and/or a color control mask 824 is arranged between the beam splitter 812 and the camera chip 808. The beam splitter 812 is arranged (optically) between a receive optic 828 and the lidar chip 804, and the beam splitter is arranged (optically) between the receive optic 828 and the camera chip 808.

Thermal infrared detectors may be used in addition to, or in lieu of, visible light sensors, which can be advantageous for detection of people, animals, and vehicles in night-time conditions. In some configurations, a chip comprises a column of light sensors (e.g., the third column 504-3 of photodetectors for detecting thermal light from the environment).

In some implementations, a number of pixels in the vertical direction, or the vertical FOV, may be less than desired due to a size and/or cost of the silicon chip used to support so many pixels. To improve the vertical resolution and/or FOV, it may be desirable to add scanning in the vertical direction and/or in the horizontal direction. On some implementations, the chip is arranged to cover half of the vertical FOV (e.g., a linear array of lasers and/or a linear array of sensors on the chip is arranged to cover half the vertical FOV). After a scan imaging the lower portion (e.g., the lower half) of the FOV, a mirror or other vertical scanning device deflects the imaging so that the subsequent scan covers the upper portion (e.g., the upper half) of the FOV. For example, the routing mirror shown FIGS. 2, 4, and 6 may be designed to pivot or scan in the vertical direction (e.g., as disclosed in commonly owned U.S. patent application Ser. No. 18/531,507, filed on Dec. 6, 2023, which is incorporated by reference for all purposes). The rotating polygon mirror in FIG. 2 (which may be a spinning, oscillating, or galvo mirror) may incorporate a pivot motion in the vertical direction as well as the horizontal scan (e.g., as disclosed in commonly owned U.S. patent application Ser. No. 18/200,457, filed on May 22, 2023, which is incorporated by reference for all purposes). In some implementations, the upper and lower scans of the FOV may butt against each other (e.g., with similar pixel spacing as spacing between sensors); in some implementations, they may overlap, providing a middle region with higher resolution than the top and bottom regions. In some configurations, the different mirror facets of the rotating polygon may have different angles in the vertical direction, each angle directing light to the detector array from a different vertical portion of the FOV. In some implementations, detectors are arranged in a sparse matrix with gaps between each detector. After each horizontal scanning pass, a vertical mirror or other vertical scanning device changes the imaging angle slightly so that a second and/or later horizontal scanning pass fills in the gaps between the pixels of the first horizontal scan.

Signals from adjacent detectors in two or more columns may be added together to increase the sensitivity of detection, sharing the same laser pulse. The signal addition may be done either in the analog or digital domain. Detectors may share a single laser, or each detector may use a different detector. In some implementations, the detectors may use two different laser pulses, either from the same or separate lasers, that are temporally separated by a time delay according to the horizontal scanning speed, such that each detector is looking at the same position in the FOV when its corresponding laser fires. For SPAD detectors, a histogram approach can be used, where multiple laser pulses are sent for each pixel, and an object is determined to be detected if more than a threshold number of pulses are detected in a given time slot. By combining multiple columns, the number of laser pulses can be reduced, or the probability of reaching the threshold of detection can be increased, effectively increasing the sensitivity.

In some embodiments, power of lasers are adjusted from a first column of detectors to a second column of detectors; detectors in a second column are less sensitive to light than detectors in a first column; gain can be changed and/or be different for detectors in different columns; detectors in the second column can be used to detect stray light from the first column; detectors can be used to image ambient light; one or more columns of detectors can be used for thermal imaging; and/or scanning can be performed in the vertical dimension as well as in the horizontal.

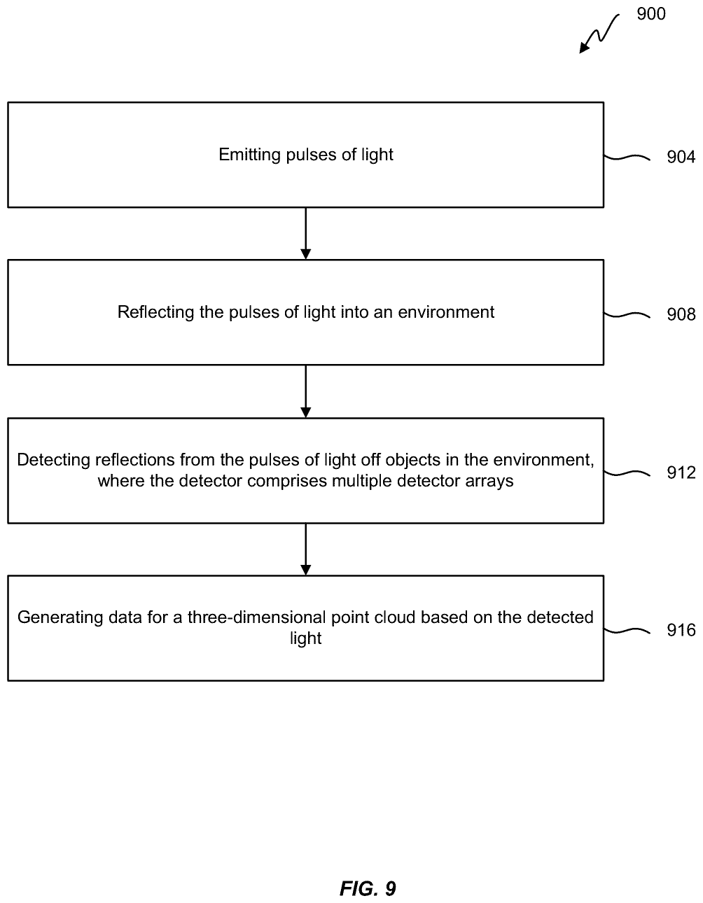

Referring next to FIG. 9, a flowchart of an embodiment of a process 900 for lidar is shown. Process 900 begins in step 904 with emitting, using one or more lasers, pulses of light. For example, light from laser 228 in FIG. 2 or from emitter 404 in FIG. 4 or FIG. 6 is emitted.

In step 908, the pulses of light are reflected into an environment using one or more mirrors. For example, mirrors 204 and 208 in FIG. 2 reflect light into FOV 220.

In step 912 light from the pulses of light reflected by one or more objects in the environment is detected using a detector. The detector comprises multiple detector arrays. For example, the detector comprises a first column of light sensors and a second column of light sensors, and the first column of light sensors detect light at a different intensity (e.g., sensitivity) than the second column of light sensors. For example, chip 500 in FIG. 5, Chip 700 in FIG. 7, or lidar chip 804 in FIG. 8 is used to detect IR light reflected in the environment off one or more objects within the environment. In some embodiments, the second column of light sensors scans a field of view before the first column of light sensor, and one or more processors adjust (e.g., increase or decrease) a power of the emitter, or adjust detector gain of the first column of light sensors, in response to data from the second column of light sensors scanning the field of view (e.g., light detected above or below a threshold by one or more sensors in the second column).

In step 916, data for a three-dimensional point cloud in generated based on light detected by the detector. The point cloud includes at least one data point for the or more objects in the environment. In some configurations, a two-dimensional image is generated based on the data from the three-dimensional point cloud. For example, lidar image data in FIG. 5 is generated from the image processing circuit 316. In some configurations, the two-dimensional image is presented to a user.

Various features described herein, e.g., methods, apparatus, computer-readable media and the like, can be realized using a combination of dedicated components, programmable processors, and/or other programmable devices. Some processes described herein can be implemented on the same processor or different processors. Where some components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Details are given in the above description to provide an understanding of the embodiments. However, it is understood that the embodiments may be practiced without some of the specific details. In some instances, well-known circuits, processes, algorithms, structures, and techniques are not shown in the figures.

While the principles of the disclosure have been described above in connection with specific apparatus and methods, it is to be understood that this description is made only by way of example and not as limitation on the scope of the disclosure. Embodiments were chosen and described in order to explain principles and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to explain the principles of the invention and its practical applications to thereby enable others skilled in the art to utilize the invention in various embodiments and with various modifications as are suited to the particular use contemplated.

What is claimed is:

1. A system for lidar comprising:
an emitter arranged to emit pulses of light;
a mirror arranged to reflect the pulses of light into an environment;
a detector arranged to detect light from the pulses of light reflected by one or more objects in the environment, wherein:
the detector comprises a first column of light sensors and a second column of light sensors; and
the second column of light sensors is arranged to scan a field of view before the first column of light sensor; and
a memory device comprising instructions that, when executed by one or more processors, causes the one or more processors to:
adjust power of the emitter, or adjust detector gain of the first column of light sensors, in response to data from the second column of light sensors scanning the field of view; and
generate data for a three-dimensional point cloud, the point cloud including at least one data point of the one or more objects in the environment based on light detected by one or more light sensors in the first column of light sensors.

2. The system of claim 1, wherein:
the emitter comprises a first column of lasers and a second column of lasers; and
the different intensity is caused by the first column of lasers emitting light at a different power than the second column of lasers.

3. The system of claim 1, wherein:
the detector further comprises an image sensor that is arranged to create a two-dimensional color image;
the image sensor is on a same chip as the first and second columns of light sensors; and
the image sensor comprises three columns of light sensors with three different colored filters.

4. A system for lidar comprising:
an emitter arranged to emit pulses of light;
a mirror arranged to reflect the pulses of light into an environment;
a detector arranged to detect light from the pulses of light reflected by one or more objects in the environment, wherein:
the detector comprises a first column of light sensors and a second column of light sensors; and
the first column of light sensors is arranged to detect light at a different intensity than the second column of light sensors; and
a memory device comprising instructions that, when executed by one or more processors, causes the one or more processors to generate data for a three-dimensional point cloud, the point cloud including at least one data point of the one or more objects in the environment based on light detected by the detector.

5. The system of claim 4, wherein the different intensity is caused by the emitter increasing or reducing power of light pulses after the second column of light sensors detects light above a threshold.

6. The system of claim 4, wherein the different intensity is caused by one or more filters in front of the first column of light sensors and/or in front of the second column of light sensors.

7. The system of claim 4, wherein the different intensity is caused by light sensors in the first column being less sensitive to light or changing gain to amplifiers receiving signals from light sensors in the first column.

8. The system of claim 4, wherein:
the detector comprises a third column of light sensors;
the first column of light sensors is between the second column of light sensors and the third column of light sensors; and
the first column of light sensors is arranged to detect light at a different intensity than the third column of light sensors.

9. The system of claim 8, wherein the instructions cause the one or more processors to use pixel data from one or more columns of light sensors that has a desired data range.

10. The system of claim 4, wherein the different intensity is caused by a gain of the first column of light sensors being reduced compared to a gain of the second column of light sensors.

11. The system of claim 4, wherein the detector further comprises four or more columns of light sensors, wherein each column of light sensors detects light at different intensities.

12. The system of claim 4, wherein:
the detector further comprises an image sensor that is arranged to create a two-dimensional color image; and
the image sensor is on a same chip as the first and second columns of light sensors.

13. The system of claim 12, wherein the image sensor, the first column of light sensors, and the second column of light sensors share a common lens.

14. The system of claim 4, wherein the system comprises an image sensor on a separate chip than the detector; and
the system comprises a beam splitter sending a first portion of light to the image sensor and a second portion of light to the detector.

15. The system of claim 4, wherein the mirror is arranged for scanning the pulses of light in a direction orthogonal to a direction of the first column of light sensors.

16. The system of claim 15, wherein:
the mirror is a first mirror;
the system comprises a second mirror; and
the second mirror is arranged to scan the pulses of light in a direction parallel to the direction of the first column of light sensors.

17. The system of claim 4, wherein generating the data for the three-dimensional point cloud includes adding data from a light sensor in the first column to data from a light sensor in the second column.

18. The system of claim 4, wherein the second column of light sensors is arranged to detect stray light emitted toward and received by the first column of light sensors.

19. The system of claim 4, wherein the detector comprises a third column of light sensors for detecting thermal light from the environment.

20. A method for lidar comprising:
emitting, using one or more lasers, pulses of light;
reflecting, using a mirror, the pulses of light into an environment;
detecting, using a detector, light from the pulses of light reflected by one or more objects in the environment, wherein:
the detector comprises a first column of light sensors and a second column of light sensors; and
the first column of light sensors detect light at a different intensity than the second column of light sensors; and
generating data for a three-dimensional point cloud based on light detected by the detector, wherein the three-dimensional point cloud includes at least one data point of the one or more objects in the environment.
